(19) United States
(12) Patent Application Publication
(10) Pub. No.: US 2022/0099830 A1
(43) Pub. Date: Mar. 31, 2022

(54) PROVIDING VISIBILITY IN TURBID WATER

(71) Applicant: Vanderbilt University, Nashville, TN (US)

(72) Inventors: Jason E. MITCHELL, Nashville, TN (US); Brett C. BYRAM, Nashville, TN (US); Joseph HOWARD, Nashville, TN (US); Christopher KHAN, Nashville, TN (US); Don TRUEX, Nashville, TN (US)

(21) Appl. No.: 17/239,436

(22) Filed: Apr. 23, 2021

Related U.S. Application Data
(60) Provisional application No. 63/014,849, filed on Apr. 24, 2020.

(51) Int. Cl. G01S 15/89

(52) U.S. Cl. CPC G01S 15/8915

(57) ABSTRACT

Visibility of a surface in turbid water can be provided using a sonar array, a plurality of acoustic mirrors, and a computing device. The sonar array can be configured to form an ultrasonic beam with a lateral dimension of a point spread function and an elevational dimension of the point spread function. The plurality of acoustic mirrors can be configured to shape and steer the point spread function. The computing device can include a non-transitory memory storing instructions and a processor configured to access the non-transitory memory and execute the instructions to sweep the ultrasound beam in the lateral dimension and the elevational dimension by moving at least one of the plurality of acoustic mirrors. Sweeping the ultrasound beam allows the processor to acquire a three dimensional data set that is used to create a projection-style reconstruction of a location in the water.

### RELATED APPLICATIONS

This application claims priority to U.S. Provisional Application Ser. No. 63/014,849, filed Apr. 24, 2020, entitled “PROVIDING VISIBILITY IN TURBID WATER USING SONAR”. The entirety of this provisional application is hereby incorporated by reference for all purposes.

### GOVERNMENT SUPPORT

This invention was made with U.S. government support under N0002419C4302 awarded by the U.S. Navy Supervisor of Salvage. The government has certain rights in this invention.

### TECHNICAL FIELD

The present disclosure relates generally to SONAR and, more specifically, to systems and methods that perform SONAR using ultrasound waves to provide visibility in turbid water.

### BACKGROUND

Navy divers perform a broad range of tasks, from routine inspection of piers and ship hulls to complex salvage/recovery operations and ships husbandry, often in turbid water with little to no visibility. Illuminating turbid water with visible or infrared light is ineffective at increasing visibility. Generally, sound waves have proven to be more effective than light-based options at improving a diver's under water sensing abilities. In fact, SONAR, an acronym for sound navigation and ranging, has long been used to detect and determine the distance and direction of underwater objects by acoustic means.

Traditionally, SONAR has been widely used with lower frequency sound waves to sense objects in turbid water in the far field. However, SONAR with these lower frequencies has a relatively low resolution and is ineffective in the near field. Higher frequency sound waves, broadly called ultrasound are typically used in medicine, but not traditionally used with SONAR in seawater. While ultrasound generally produces higher resolution images in the near field, commercial ultrasound systems (operating in either a 2-D or 3-D fashion) are not adequate in their current form for conditions encountered by a diver because ultrasound transducers have a limited field of view (e.g., ˜60 degrees) and limited depth of view (e.g., less than 14 inches). Moreover, commercial ultrasound systems are not open source and code cannot be optimized for turbid seawater or hard objects.

### SUMMARY

Provided herein are systems and methods that can use ultrasound waves for the SONAR application of providing visibility in turbid water. The systems and methods can utilize a sonar array of advanced ultrasound transducers, one or more acoustic mirrors, as well as a targeted ultrasound algorithm. In some instances, the sonar array and the acoustic mirrors can be within one or more pressure hardened enclosures. Work can be done in turbid water to a level never before possible because the systems and methods described herein can give divers a way to see their surroundings to perform detailed work in turbid water.

In an aspect, the present disclosure can include a system that provides visibility in turbid water. The system includes a sonar array configured to form an ultrasonic beam with a lateral dimension of a point spread function and an elevational dimension of the point spread function. The system also includes a plurality of acoustic mirrors configured to shape and steer the point spread function and a computing device. The computing device includes a non-transitory memory storing instructions and a processor configured to access the non-transitory memory and execute the instructions to sweep the ultrasound beam in the lateral dimension and the elevational dimension by moving at least one of the plurality of acoustic mirrors, wherein sweeping the ultrasound beam allows the processor to acquire a three dimensional data set that is used to create a projection-style reconstruction of a location in the water.

In another aspect, the present disclosure can include a method for providing visibility in turbid water with the following steps. Forming, by a sonar array, an ultrasonic beam with a lateral dimension of a point spread function and an elevation dimension of the point spread function. Steering, by a system comprising a processor, the ultrasonic beam in the lateral dimension and the elevational dimension over a location in the water by moving at least one of a plurality of acoustic mirrors, wherein the location is based on the lateral dimension and the elevational dimension. And, acquiring, by the system, a three dimensional data set that is used to create a projection-style reconstruction of the location.

### BRIEF DESCRIPTION OF THE DRAWINGS

The foregoing and other features of the present disclosure will become apparent to those skilled in the art to which the present disclosure relates upon reading the following description with reference to the accompanying drawings, in which:

FIG. 1 is a diagram showing an example system that can perform SONAR using ultrasound waves to provide visibility in turbid water in accordance with an aspect of the present disclosure;

FIG. 2 is a diagram showing an example device that can be used in the system of FIG. 1;

FIGS. 3 and 4 are process flow diagrams illustrating methods for performing SONAR using ultrasound waves to provide visibility in turbid water in accordance with another aspect of the present disclosure.

### DETAILED DESCRIPTION

### I. Definitions

Unless otherwise defined, all technical terms used herein have the same meaning as commonly understood by one of ordinary skill in the art to which the present disclosure pertains.

As used herein, the singular forms “a,” “an” and “the” can also include the plural forms, unless the context clearly indicates otherwise.

As used herein, the terms “comprises” and/or “comprising,” can specify the presence of stated features, steps, operations, elements, and/or components, but do not preclude the presence or addition of one or more other features, steps, operations, elements, components, and/or groups.

As used herein, the term “and/or” can include any and all combinations of one or more of the associated listed items.

As used herein, the terms “first,” “second,” etc. should not limit the elements being described by these terms. These terms are only used to distinguish one element from another. Thus, a “first” element discussed below could also be termed a “second” element without departing from the teachings of the present disclosure. The sequence of operations (or acts/steps) is not limited to the order presented in the claims or figures unless specifically indicated otherwise.

As used herein, the term “SONAR” (both capitalized and not capitalized) is an acronym for sound navigation and ranging, and can refer to a technique for detecting and determining the distance and direction of underwater objects by acoustic means.

As used herein, the term “ultrasound”, also including “ultrasonic beam”, “ultrasound wave”, or the like, can refer to high frequency sound waves or the act of producing high frequency sound waves. For example, ultrasound waves can have frequencies higher than the upper audible limit of human hearing (e.g., 15 kHz or higher). Ultrasound can be used for location and measurement in the near field. A specific ultrasound beam can be formed with a lateral dimension and an elevational dimension of a point spread function.

As used herein, the term ultrasound, ultrasonic, or the like, “transducer” can refer to a device that produces sound waves that bounce off something being imaged and make echoes. In some instances, the device or a component of the device can receive the echoes and send them, or a related signal, to a computer that uses the echoes to create a sonogram image. In some instances, the ultrasonic transducer can be a piezoelectric element. The device can be or can include, for example, a transmitter, a receiver, and/or a transceiver. When used herein, the term “transducer” can refer to the device, which may include one or more ultrasound transducers arranged in a particular manner (e.g., a sonar array) within a housing (e.g., including a plastic shell, one or more acoustic insulators, one or more acoustic shields, one or more moveable mirrors, etc.).

As used herein, the term “near field” can refer to an area (or Fresnel zone) where a sonar pulse maintains a relatively constant diameter that can be used for imaging. In this region, the diameter of the beam can be determined by the diameter of the transducer. The length of the near field is related to the diameter of the transducer, D, and the wavelength, I, of the sonar by D²/4I.

As used herein, the term “turbid” can refer to a liquid that is cloudy, opaque, or thick with suspended matter. Turbidity is caused by large numbers of individual particles that are generally invisible to the naked eye when alone, but cause loss of visibility in large numbers.

As used herein, the term “visibility” can refer to the state of being able to be seen.

As used herein, the term “high resolution” can refer to showing a large amount of detail in an image (e.g., fine detail). As an example, resolution can refer to spatial resolution.

As used herein, the term “sensor” can refer to a device that detects or measures a physical property and records, indicates, or otherwise responds to the physical property. In some instances a sensor can be in communication with at least one other device such as a controller, transducer, etc.

As used herein, the terms “user” and “diver” (and similar terms) can be used interchangeably and can refer to any organism or machine capable of doing work under water. For example, the user can be a navy diver, but may also be a rescue diver, a coast guard diver, a police diver, a scuba diver, or the like. As another example, the user can be a robot, robotic component, or the like.

As used herein, the term “acoustic mirror” can refer to a device used to reflect and focus (e.g., concentrate) sound waves.

As used herein, the term “projection-style reconstruction” can refer to an image reconstruction recreated from a single sweep, which is composed of multiple tomographic slices.

### II. Overview

SONAR has been used to detect and determine the distance and direction of underwater objects by acoustic means (similar to echolocation used by animals like bats and dolphins). Traditional marine applications of SONAR, widely used at a lower frequency (e.g., hundreds of kHz or less), have been focused on detecting large objects, such as large watercraft and marine mammals, over large distances. Short range, high frequency (e.g., between 100 kHz and 3 MHz) SONAR can provide a working distance in the tens of meters and is intended for surveillance of nearby, but not immediately adjacent, structures and navigation therearound; however, SONAR does not enable visibility within arm range. SONAR with these lower frequencies (e.g., 3 MHz or less) has a relatively low resolution and is ineffective in the near field, but higher frequency sound waves (broadly referred to as ultrasound) are effective in the near field, as shown by their use in the medical field. Existing medical ultrasound systems operate at high frequencies (1-15+ MHz) and high resolutions (˜0.1-0.5 mm or 0.004-0.02 inch) within normal operating limits in the near field, such that visualization can occur up to the face of the ultrasound transducer, if necessary. Existing ultrasound platforms are power output limited and are not designed to image more than 8-12 inches deep. In addition, medical ultrasound transducers do not have the necessary hardware and software for existing ultrasound systems to adapt to realize the necessary field of view.

The present disclosure describes systems and methods that use ultrasound waves for the SONAR application of providing visibility in turbid water. The systems and methods overcome the limitations of previous solutions by employing new techniques for high speed surface scanning that provide working near-field visualization for underwater operations requiring visualization and manipulation of small objects within the working distance of divers. The systems and methods can utilize a sonar array, which can form an ultrasonic beam with a lateral dimension of a point spread function and an elevational dimension of the point spread function, a plurality of acoustic mirrors, which can shape and steer the point spread function, and a computing device, which can sweep the ultrasound beam in the lateral dimension and the elevational dimension by moving at least one of the plurality of acoustic mirrors. Sweeping the ultrasound beam allows the processor to acquire a three dimensional data set that is used to create a projection-style reconstruction of a location in the water. Another important development of the present disclosure is the utilization of a surface sweep enabling intuitive projection visualization instead of the traditional tomographic visualization provided by SONAR and ultrasound devices. In order to provide sufficiently rapid beam sweeping to enable projection type visualizations, full field insonification (e.g., where a full field-of-view tomographic image is created from each transmission) is utilized and integrated with a rotating or sweeping acoustic mirror to allow for rapid translation of the beam through the out of plane dimension.

### III. Systems

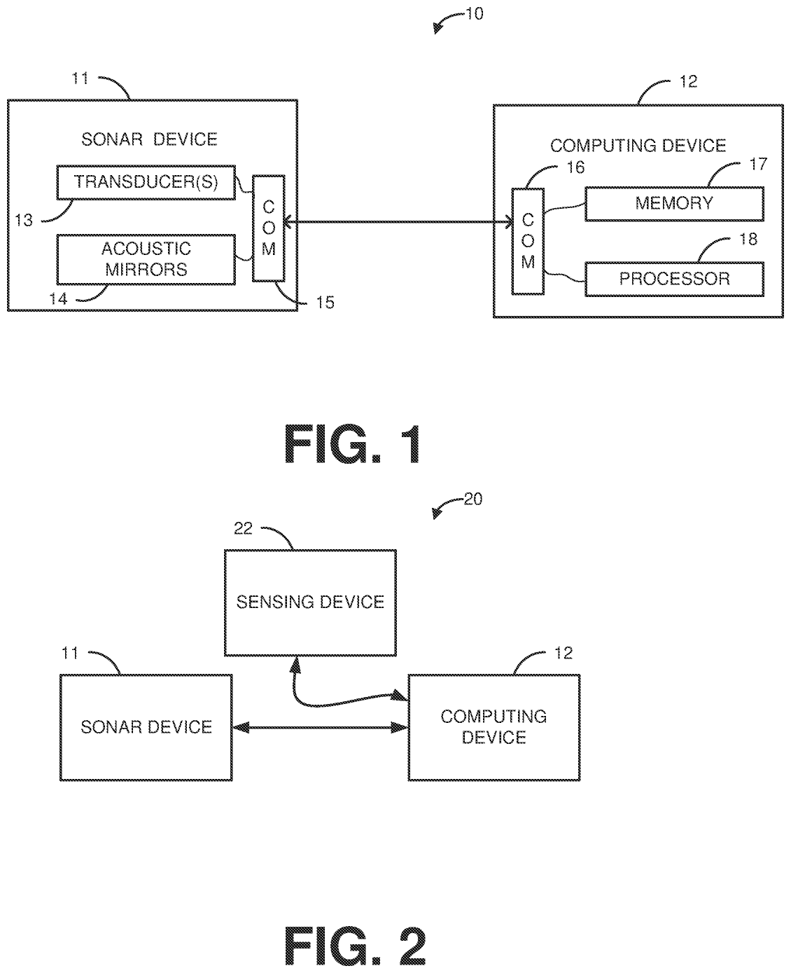

An aspect of the present disclosure can include a system 10 (FIG. 1) that can provide visibility in turbid water. The system 10 can perform SONAR using ultrasound waves to provide visibility in turbid water. The system 10 overcomes limitations of the hardware and software of existing state-of the art SONAR and ultrasound systems. The system 10 can image to a depth (e.g., 3 feet or more) from a user, while providing near-field visualization up to the face of the transducer array 12. Moreover, the system 10 can operate at high frequencies (e.g., ultrasonic frequencies) to enable improved resolution compared to other SONAR devices/systems. The system 10 also can utilize a surface sweep, enabling intuitive projection visualization instead of traditional tomographic visualization provided by traditional SONAR and ultrasound devices. While projection images are immediately intuitive, projection images are complex to obtain, so other SONAR and ultrasound systems have not dealt with the complexity of projection images, despite their superior readability. The system 10 allows divers to “see” (or visualize) their surroundings so they can do detailed work in turbid water. The system 10 uses the ultrasound waves to perform SONAR, which provides working near-field visualization for underwater operations. The near-field visualization allows divers to perform manipulation of objects within the working distance of the divers.

The system 10 includes a transducer array 12 (also referred to as a SONAR array) of one or more ultrasound transducers (which may be of the same or different sizes and shapes). As an example, the one or more ultrasound transducers can include one or more piezoelectric elements and/or the one or more ultrasound transducers can be constructed from a piezoelectric material. In another example, the one or more ultrasound transducers can be a customized array of multiple piezoelectric elements. Each of the one or more ultrasound transducers can be configured to form an ultrasonic beam. The system 10 also includes one or more acoustic mirrors 14. For example, the system 10 can include a plurality of acoustic mirrors 14. At least a portion of the acoustic mirror(s) 14 can be moveable/deformable/translatable (e.g., by hand and/or by an instruction from a computing device 16 to a motor connected to the acoustic mirrors (not shown)). The acoustic mirror(s) 14 can be configured to shape and steer the point spread function (e.g., to change the focal distance of the ultrasound beam). The acoustic mirrors 14 can include an acoustic sweeping mirror, an acoustic focusing mirror, an acoustic conditioning mirror, or the like; however, the acoustic mirror(s) 14 need not be mirrors and may instead be lenses. The acoustic mirror(s) 14 may be reflective and/or refractive mirrors or lenses, or a combination thereof. Moreover, the acoustic mirror(s) 14 can also include a deformable wave guide, lens movement circuitry/components, lens deformation circuitry/components, and the like.

The transducer array 12 can be configured to provide an ultrasound beam (in some instances, also referred to as a sonar beam). The ultrasound beam can be shaped according to a point spread function with a lateral dimension (shaped according to a standard array beamforming shape, algorithms, and/or lenses/mirrors) and an elevational dimension. In other words, the ultrasonic beam can have a lateral dimension and an elevational dimension of a point spread function. The acoustic mirror(s) 14 can be arranged in a way to steer, sweep, condition, or the like, an aspect of the point spread function. For example, the acoustic mirror(s) 14 can be arranged to control the shape of the point spread function, emphasize a characteristic of the point spread function, and/or steer the point spread function.

As an example, the one or more transducers of transducer array 12 can be arranged in an array that can use standard array beamforming to shape the lateral dimension, but can rely on the one or more acoustic mirrors 14 and/or the timing characteristics of the one or more transducers to set and/or dynamically update the elevational dimension, giving high sensitivity and resolution at all depths. In other examples, the lateral dimension or the lateral dimension and the elevational dimension can be shaped by the one or more acoustic mirrors 14 and/or the timing characteristics of the one or more transducers to set and/or dynamically update the lateral dimensions or the lateral and elevational dimensions.

A computing device 16 can receive data from and/or send instructions to the transducer array 12 and the acoustic mirror(s) 14. In some instances, the computing device 16 can be separate from the transducer array 12 and the acoustic mirror(s) 14. In other instances, a portion of the computing device 16 can be separate from the transducer array 12 and the acoustic mirror(s) 14. For example, the computing device 16 can be a separate device that can be watertight and worn by the diver while under water. In this example, the transducer array 12 and the acoustic mirror(s) 14 can be connected to the computing device 16 be a wired and/or a wireless connection. In some instances, the transducer array 12 and the acoustic mirror(s) 14 can be connected to one or more communication mechanisms, which can be connected to a similar communication mechanism in the computing device 16 (the computing device 16 need not have a specific communication mechanism). Additionally, each of the transducer array 12 and the acoustic mirror(s) 14 can be associated with one or more drive circuits, motors, or the like (allowing for high precision control). The communication mechanisms can ensure that the computing device 16 can read the information provided by the transducer array 12 and the acoustic mirror(s) 14 and vice versa. In some instances, the computing device 16 can have at least rudimentary image processing capabilities, in which image processing techniques are incorporated to perform image analysis, feature recognition, or the like.

The computing device 16 also includes a memory 17 (storing instructions and data) and a processor 18 (to access the memory and execute the instructions/use the data). In some instances, the memory 17 and the processor 18 can be separate components. In other instances, the memory 17 and the processor 18 can be within the same component. It should be noted in some instances that the computing device 16 does not provide its own power, yet is connected to a power supply that is outside of the water (e.g., connected via at least one cable). The computing device 16 or an alternate device can have image processing and/or beam forming circuitry/programming capabilities.

The computing device 16 can have instructions stored/executed (e.g., within software or algorithms) that can move the one or more acoustic mirrors 14 and/or activate/set the timing of the one or more transducers of the transducer array 12. The processor 18 can be configured to access the memory 17 to execute the instructions to sweep the ultrasound beam in the lateral dimension and/or the elevational dimension. The sweeping can be based on the configuration of the hardware, as well as the algorithm executed in software, to produce a surface scan of a predetermined field of view (e.g., of an area at a depth). The ultrasound beam can be swept by moving and/or focusing at least one of the acoustic mirror(s) 14 within the water to a depth, a focal point, or the like (e.g., a first acoustic mirror can be moved, then a second acoustic mirror can be moved based on a depth, location, or the like, that is a target for the visualization). The sweeping can also involve varying a timing of one or more of the transducer elements (e.g., piezoelectric elements) in the transducer array 12. Sweeping the ultrasound beam allows the processor to acquire a three dimensional data set that is used to create a projection-style reconstruction of a location in the water.

As shown in FIG. 2, control 22 that controls aspects associated with the transducer array 12 and/or the acoustic mirror(s) 14 can be within the housing 24. The control 22 can be part of the computing device 16 or can communicate with the computing device 16. One or more sensors 26 can be attached to/incorporated within the housing 24. The one or more sensors 26, in some instances, can monitor changing acoustic properties of water due to factors like salinity, pressure, temperature, and the like. In other instances, the one or more sensors 26 can measure a change in a structural condition of the transducer array 12 and/or the acoustic mirror(s) 14. For example, the structural change can be due to structural distortions in the environment (e.g., due to pressure and/or temperature) and the computing device 16 can adjust the image quality requirements and/or increase speed to mitigate and/or remove the effects of the distortions.

In some instances, as shown in FIG. 2, the transducer array 12 and the acoustic mirror(s) 14 can be within a common housing 24. However, the transducer array 12 and the acoustic mirror(s) 14 need not be in a common housing (and may be within their own individual housings, for example). The common housing 24 and/or individual housings can be water tight (or at least substantially water tight) to keep the transducer array 12, the acoustic mirrors 14, and any additional mechanical or electrical components away from the water when submerged. As an example, the housing 24 and/or individual housings can be pressure hardened to enclose the transducer array 12, the acoustic mirror(s) 14, and other mechanical/electrical components therein.

In some instances, the system 10 can be in the form of a diver-wearable ultrasound SONAR system (transducer, embedded systems/firmware, and algorithms) that can sense the environment and provide input to a heads-up display visualization (e.g., a Divers Augmented Visualization Device (DAVD)). The DAVD is an existing heads-up display visualization technology that can be installed in a diving helmet, mask, or the like. It should be understood that the DAVD is merely an example of how/where the system 10 can be installed. The system 10 can interface with the DAVD or other heads-up display visualization directly. The system 10 can enable near-field visualization for underwater operations requiring visualization and manipulation of small objects within the working distance of divers integrated with comparatively deep visualization at high frequencies, while employing new techniques for high speed surface scanning.

In the example of system 10 interfacing with the DAVD, the following objective and threshold parameters are established for components of the system 10.

| Item | Objective | Threshold |
|---|---|---|
| Size | 2-inch diameter 5-inch | |
| | length | |
| Helmet mounted | Air: 5 lbs | Air: 15 lbs |
| equipment weight | Water: Neutral | Water: 5 lbs |
| Operation Depth | 300 fsw | 190 fsw |
| Environmental Conditions | 38° F. | 90° F. |
| Visual Range. | 1 to 60 inches from diver's | 6 to 36 inches from diver's |
| | faceplate | faceplate |
| Field of View | 150° field of view. | 120° field of view. |
| Resolution | 0.0625 inches | 0.125 inches |
| Frame Rate | 60 frames per second | 45 frames per second |
| Compatibility | Provide input in format | |
| | required by DAVD | |

By interfacing with the DAVD or other heads-up display visualization, the system 10 can allow divers to perform inspections, ship's husbandry, salvage, and countless other tasks in turbid water with visual feedback where the divers typically have to rely on tactile feedback. The system 10 can allow the divers to perform tasks with much finer detail much more quickly. The finer detail is due to projection-type visualizations provided by the system 10.

In order to provide sufficiently rapid beam sweeping to enable projection-type visualizations, the system 10 utilizes full field insonification where a full field-of-view tomographic image is created from each transmission. Full-field insonification is created using the ultrasound beam and one or more rotating or sweeping acoustic mirrors to allow for rapid translation of the ultrasonic beam through the out of plane dimension. This combination of broad-field insonification, parallel beamforming, and acoustic mirror are integrated in the system 10 to create quickly acquired volumetric data sets for diver visualization. For example, the transducer array 12 can be a 128-element ultrasound array (but the size is not limited thereto) driven by a programmable +/−100 V power supply.

In one example, a rotating acoustically reflective (e.g., metal) surface (e.g., an acoustic mirror) can be used to steer the ultrasonic beam through the elevational dimension. In order to shape the elevational dimension of the point spread function a shallow spherical or parabolic curvature can be introduced to the surface in order to focus the beam at a given depth. This curvature is imposed on all sides of the rotating surface. The radius of curvature can be selected based on the desired focal distance.

In another example, a rotating surface can be used for steering. Instead, 2 or more stationary mirrors that each have a spherical or parabolic curvature can be used to more gradually focus the beam.

In another example, a beam expander can be used before the wave arrives at a steering mirror. A series of two mirrors can be the beam expander that can increase the elevational dimension of the propagating beam before it is focused. This is beneficial because the ability of a mirror or lens to focus is inversely proportional to the width of the intersection of the beam and the focusing device. The beam expander increases the size of this intersection so that the resolution at the focus is improved. Multiple lenses/mirrors can be implemented after the beam expander.

### IV. Methods

Another aspect of the present disclosure can include methods 30 and 40 for performing SONAR using ultrasound waves to provide visibility in turbid water. The methods 30 and 40 can be executed using the systems 10 and 20 shown in FIGS. 1 and 2. One or more of the steps of methods 30 and/or 40 can be stored in a non-transitory memory (e.g., any computer memory that is not a transitory signal) and executed by a processor (e.g., any hardware processor).

For purposes of simplicity, the methods 30 and 40 are shown and described as being executed serially; however, it is to be understood and appreciated that the present disclosure is not limited by the illustrated order as some steps could occur in different orders and/or concurrently with other steps shown and described herein. Moreover, not all illustrated aspects may be required to implement the methods 30 and 40, nor are the methods 30 and 40 necessarily limited to the illustrated aspects.

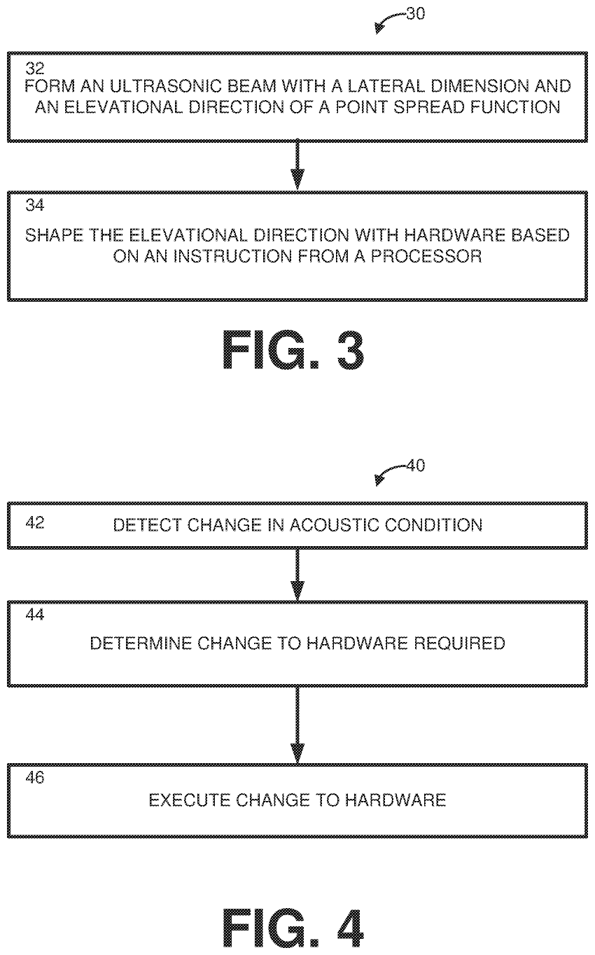

Referring now to FIG. 3, illustrated is a method 30 that can provide visibility in turbid water. At 32, an ultrasonic beam can be formed (e.g., by a sonar array, also referred to as transducer array 12). The sonar array can be formed of one or more ultrasound transducers, which can be made of piezoelectric elements. The ultrasound beam can have a lateral dimension of a point spread function and an elevational dimension of the point spread function. For example, the lateral dimension of the point spread function can be shaped according to a standard array beamforming shape.

At 34, the ultrasonic beam can be steered (e.g., by a system that includes at least a processor) over a location (with a beam having a lateral dimension value and an elevation dimension value) in turbid water. The ultrasonic beam can be steered in the lateral dimension and/or the elevational dimension. The steering can be accomplished by moving at least by one of a plurality of acoustic mirrors (including a reflective mirror, a refractive mirror, an acoustic sweeping mirror, an acoustic focusing mirror, an acoustic conditioning mirror, a deformable wave guide, a moveable lens, a deformable lens, other components, etc.) to guide the ultrasonic beam (e.g., with a motor, driver, etc.) and/or by varying at least one of the ultrasonic transducers (e.g., timing of individual elements of the array). The steering can be accomplished in response to an instruction by a computing device. As an example, at least one of the acoustic mirrors can be moved based on a depth (beneath the water and/or beneath the camera) within the water of the location. At 44, a three dimensional data set (e.g., recorded by tone or more transducers in the array of transducers) can be acquired. The three dimensional data set can be used to create a projection-style reconstruction of the location.

Projection-style reconstruction is different from traditional medical ultrasound and sonar, which natively produce tomographic images. Tomographic images produce cross-sections through objects. As an example, tomographic scans are used to guide needles to tumors for biopsy, which requires careful coordination of the needle and the imaging device, necessitating substantial training, and this kind of coordination may not be possible in the operational environments encountered by divers. Compared to tomographic imaging, projection images are intuitive because it matches our standard visual interaction with the world. Again, while SONAR itself is a natively tomographic method, it is often used to produce projections such as with multibeam and side scan SONAR images used in sea floor depth mapping.

FIG. 4 shows a method 40 that can employ one or more sensors when providing visibility in turbid water. At 42, a change in acoustic condition (e.g., of the water, like a turbidity condition or the pressure/temperature/etc., a structural condition of the sonar array or at least one of the plurality of mirrors, or the like) can be detected (e.g., by one or more sensors). The sensors can be on and/or within a device that includes the array of ultrasound transducers and/or the acoustic mirror(s). The detected change in acoustic condition can be received the computing device. At 44, a change to hardware (e.g., one or more acoustic mirrors and/or ultrasound transducers of the sonar array) required by the change in acoustic condition can be determined. A required change in the hardware of the one or more acoustic mirrors and/or the ultrasound transducers can be in response to the determined change in position. At 46, the required change to the hardware can be executed/made (e.g., based on a signal from the computing device). For example, the change can be made by sending a signal from the computing device to a motor/driver/transducer/etc. and then checking to see if the visibility has improved.

From the above description, those skilled in the art will perceive improvements, changes and modifications. Such improvements, changes and modifications are within the skill of one in the art and are intended to be covered by the appended claims.

The following is claimed:

1. A system that provides visibility in turbid water comprising:
a sonar array configured to form an ultrasonic beam with a lateral dimension of a point spread function and an elevational dimension of the point spread function;
a plurality of acoustic mirrors configured to shape and steer the point spread function; and
a computing device comprising:
non-transitory memory storing instructions; and
a processor configured to access the non-transitory memory and execute the instructions to sweep the ultrasound beam in the lateral dimension and the elevational dimension by moving at least one of the plurality of acoustic mirrors, wherein sweeping the ultrasound beam allows the processor to acquire a three dimensional data set that is used to create a projection-style reconstruction of a location in the water.

2. The system of claim 1, wherein the sonar array comprises multiple piezoelectric elements.

3. The system of claim 2, wherein the processor executes the instructions to vary a timing of at least one of the multiple piezoelectric elements to sweep the ultrasonic beam.

4. The system of claim 1, wherein the processor executes the instructions to move another of the plurality of acoustic mirrors based on a depth of the location within the water.

5. The system of claim 1, wherein the plurality of acoustic mirrors comprises at least one of an acoustic sweeping mirror, an acoustic focusing mirror, and an acoustic conditioning mirror.

6. The system of claim 1, wherein the processor executes the instructions to focus at least one of the plurality of acoustic mirrors.

7. The system of claim 1, wherein the plurality of acoustic mirrors comprises at least one of a deformable wave guide, a moveable lens, and a deformable lens.

8. The system of claim 1, further comprising at least one sensor to detect a change in an acoustic condition of the water.

9. The system of claim 1, further comprising at least one sensor to detect a change in a structural condition of the sonar array and/or at least one of the plurality of mirrors.

10. The system of claim 1, wherein the plurality of acoustic mirrors comprises reflective mirrors and/or refractive mirrors.

11. The system of claim 1, wherein the lateral dimension of the point spread function is shaped according to a standard array beamforming shape.

12. A method for providing visibility in turbid water comprising:
forming, by an sonar array, an ultrasonic beam with a lateral dimension of a point spread function and an elevational dimension of the point spread function;
steering, by a system comprising a processor, the ultrasonic beam in the lateral dimension and the elevational dimension over a location in the water by moving at least one of a plurality of acoustic mirrors, wherein the location is based on the lateral dimension and the elevational dimension; and
acquiring, by the system, a three dimensional data set that is used to create a projection-style reconstruction of the location.

13. The method of claim 12, wherein the sonar array comprises multiple piezoelectric elements.

14. The method of claim 13, wherein the steering further comprises varying a timing of at least one of the multiple piezoelectric elements.

15. The method of claim 12, wherein the steering further comprises moving another of the plurality of acoustic mirrors based on a depth of the location within the water.

16. The method of claim 12, wherein the lateral dimension of the point spread function is shaped according to a standard array beamforming shape.

17. The method of claim 12, wherein the plurality of acoustic mirrors comprises reflective mirrors and/or refractive mirrors.

18. The method of claim 12, further comprising detecting, by at least one sensor, a change in an acoustic condition of the water and/or a structural condition of the sonar array and/or at least one of the plurality of mirrors.

19. The method of claim 12, wherein the plurality of acoustic mirrors comprises at least one of a deformable wave guide, a moveable lens, and a deformable lens.

20. The method of claim 12, wherein the plurality of acoustic mirrors comprises at least one of an acoustic sweeping mirror, an acoustic focusing mirror, and an acoustic conditioning mirror.
